(19) United States
(12) Patent Application Publication
(10) Pub. No.: US 2006/0117105 A1
(43) Pub. Date: Jun. 1, 2006

(54) Devices and methods for conditional execution decision making in relation to services received and creation of information messages associated with said services, and associated products

(75) Inventors: Laurent Lesenne, Acigne (FR); Frederic Pasquier, Laille (FR)

Correspondence Address: THOMSON LICENSING INC., PATENT OPERATIONS, PO BOX 5312, PRINCETON, NJ, 08543-5312, US

(73) Assignee: THOMSON LICENSING S.A., Boulogne (FR)

(21) Appl. No.: 10/540,117

(22) PCT Filed: Dec. 29, 2003
(86) PCT No.: PCT/EP03/51107

§ 371 Date: Jun. 20, 2005

(30) Foreign Application Priority Data
Jan. 2, 2003 (FR) 0300011

(51) Int. Cl. G06F 15/173

(52) U.S. Cl. 709/226; 709/223

(57) ABSTRACT

The present invention relates to a conditional decision device and method for the execution of services received, having predetermined life spans. This device receives and identifies information relating to computer programs required for the execution of these services. It checks the local availability of these programs and allows the services to be executed if the associated programs are available locally. Furthermore, it is capable of triggering a downloading of the programs when the latter are not available locally, and allowing or preventing such a download, at least according to information associated with the services. The invention also relates to a device and a method for compiling associated messages. Application to ATVEF and MHP standards.

The present invention relates on the one hand to conditional decision devices and methods for the execution of services received and on the other hand to devices and methods for the compilation of information messages associated with services, and associated products.

It applies to interactive televisions and to set-top-boxes (STBs), enabling users to interact with interactive services. For this, these terminals are normally connected to one or two communication networks comprising a bidirectional network (modem return channel, cable, etc.) of the point-to-point type (such as the telephone network) and an analog or digital one-way distribution network (microwave, cable, satellite TV transmission network). The description below is concerned more particularly with interactive consumer terminals, which include in particular receivers such as those marketed under the brand name TAK (eTV), DVB (Digital Video Broadcasting) decoders and Internet decoders.

In such a terminal, the execution of interactive services in addition to the transmitted programs, is based on specific features of the terminal, in particular for the display. These specific features more often than not take the form of an embedded software set, including plug-ins, that is, application software in addition to existing software, which are automatically activated in the presence of multimedia objects without requiring intervention from the user. The plug-ins are normally associated with Web browsers. Often downloaded free of charge over the Internet, they are used, for example, to listen to sounds or view videos. For example, a very widely used plug-in is the one marketed under the name “Flash” by Macromedia. This Internet page animation plug-in is used to insert animations in HTML (HyperText Markup Language) format pages.

The service providers are mainly broadcasters, or advertisers. A service operator controls the transmission of the interactive services, by virtue of a contract signed with a provider, direct or indirect (by subcontracting), of these services. The latter normally concern either live events or televised games (the provider is then a broadcaster), or interactive promotions (the provider is then an advertiser). In both cases, the service operator undertakes to transmit the services correctly (number and scheduling of the transmissions, correct execution, etc.) and, in addition to a certain quality of service, ensures reception by as many terminals as possible.

Thus, the interactive consumer terminals receive enhanced programs, in other words audio-visual programs with which interactive services are linked. Each interactive service conventionally comprises, for transmissions according to the ATVEF (Advanced Television Enhancement Forum) standard, HTML pages and dependencies such as pictures in GIF (Graphics Interchange Format) or JPEG (Joint Photographic Experts Group) formats, or Flash animations. This operation is similar for transmissions according to the DVB-MHP (Multimedia Home Platform) standard, this standard also being based on HTML.

Typically, when an enhanced program is broadcast, the terminal begins by acquiring the interactive service. Then, the reception of a signal sent by the operator provokes the appearance of a graphic or textual display superimposed on the video, prompting the user to interact with this service. If appropriate, depending on the operator's choice, this prompt is bypassed and the service appears directly. In the ATVEF context, the transmission and display of the interactive service comprise the following steps:
transmission of a service announcement message notifying the terminal that interactivity is present; the terminal then listens for the content of the interactive service, therefore awaiting reception of the HTML pages and of all the dependencies that make up this service, and instructions to execute this service in the form of triggers (display triggers, but also service update triggers);
transmission of the content;
and transmission of the triggers.

In the MHP context, the operation is similar, the service announcement message taking the form of a signaling.

Now, the plug-ins evolve very quickly and there are numerous successive versions. Thus, the Flash plug-in currently comprises in particular the Flash3, Flash4 and Flash5 versions, all of which are very widely used. A terminal having the Flash5 plug-in can then display Flash3 animations, but if it has only Flash3, it is incapable of displaying correctly an HTML page containing an animation done in Flash4 or Flash5 mode. Furthermore, the service providers tend always to want to use the latest plug-in versions, to obtain maximum benefit from their capabilities and to put the finishing touches to the presentation of their interactive services.

On the interactive terminals side, it is therefore necessary to make regular updates. As long as the services are operated by a single entity towards uniform targets, such operations can still be controlled. However, when two service operators are operational or the target installed base of STBs or interactive TVs becomes non-uniform, difficulties arise. Thus, if a terminal has not been updated in a recent software downloading campaign, for example, this terminal may no longer be able to display certain transmitted interactive services. Now it is probable for the consumer applications that the installed base of terminals is effectively non-uniform, not all the terminals having been systematically updated.

To confront this problem, it is known to proceed in such a way that the transmitted services indicate to the terminals the plug-ins and their versions required for perfect execution. The terminal can then decide whether to execute the service according to the means available to it, even if it means displaying an HTML page in degraded mode if it has a less powerful version than the one indicated, but nevertheless one that can be used for this service.

This approach contrasts with that of the information technology world, in which the user is prompted to download the most recent version of the required plug-in, for example to display an HTML page. This choice by the user is not then a problem, since the request is addressed to a relatively aware public and the downloading time has no effect on the quality of service (not synchronized with a transmission). By analogy with the IT world, if the user of an interactive terminal uses the bidirectional network to request information even if he does not have the latest required plug-in version, a degraded mode display is also acceptable, given that it is the user himself who takes the initiative to execute the service.

On the other hand, in the case of a service received by broadcasting, it is important for the service (for example, an interactive promotion) to be executed perfectly on all the consumer terminals that receive it, in accordance with the contract entered into previously between the operator and the service provider. The degraded mode display, like non-execution of the service, run the risk of being highly prejudicial to the quality of the services provided.

The MHP standard, in its most recent version 1.1.1 (ETSI TS 102 812 V1.1.1) provides for the indication, in the signaling, of information concerning the plug-ins required to execute the associated services (section 10.13.2), such as the identity of the plug-in application and its start-up mode. Furthermore (section 10.13.3) provides for being able to associate each application executable by means of a plug-in with a number of plug-ins, each of which can be used for this purpose, arranged in order of preference (including one by default). However, the standard remains silent on the use of this information when none of the plug-ins that can be used for an application to be executed is available locally in the terminal. In all probability, current usages in this field lead to the execution of the service being refused.

In order to partially resolve the difficulties raised by the non-execution of services, or their approximate execution, it could be possible to envisage systematically downloading the preferred plug-ins required in an MHP signaling, when the latter are not available locally. Such a solution would at least make it possible to anticipate subsequent requirements concerning these plug-ins.

However, the problem of execution of services relying on a plug-in not yet available would continue to be detrimental. In practice, it is probable that, in a large number of cases, downloading would not be finished when the contents and triggers are received. Not only would there then be a risk that the received service could not be executed, but the terminal would often needlessly acquire the content of this service. Furthermore, an automatic operation to download plug-ins would risk being problematical in many respects, in particular in terms of bandwidth and storage space occupancy.

This is why the most natural solution would seem to involve conditionally executing the application concerned, according to whether the required plug-ins (mentioned in the signaling) are available locally or not, even if it means taking into account missing plug-ins to perfect a local update management involving a user. Such an update process based on polling of a terminal would in any case only be of value for the future, and would therefore not be applicable to the services requesting for the first time a new version of a plug-in, or a plug-in for which the need had not yet been felt.

The present invention proposes a conditional decision device for the execution of received services, which overcomes many of the above difficulties, by making it possible to significantly reduce the number of cases in which the services cannot be executed, while avoiding download operations that are prejudicial to the use of the terminals concerned and a management that is complex and tedious for the users. Furthermore, the conditional decision device of the invention may facilitate a flexible and effective updating of the functionalities available in the terminals.

The invention also relates to a conditional execution decision method corresponding to the decision device of the invention, and to a device and a method for compiling information messages and associated products.

It applies in particular to the field of television, but can also be advantageously applied to radio, and any other sector that might involve the transmission of services having predetermined life spans. Furthermore, it can be operated equally in analog and digital environments.

The term “service” is understood here to mean a set of functionalities intended for transmission to terminals and for execution thereon, in parallel with the reception by these terminals of programs transmitted by broadcasting. This service may or may not be interactive, the interactivity itself possibly being local (communication between a user and his terminal) or remote via a return channel (communication between a user and a service operator via the terminal).

Thus, the object of the invention is to produce a conditional decision device for the execution of services received via a communication network, said received services having predetermined life spans. The device comprises:
a module for receiving information associated with the services, provided to receive this information prior to the execution of the associated services,
a module for identifying, from the information received, information concerning computer programs required to execute the services associated with this information,
a module for checking the local availability of the identified computer programs,
and a selective decision module for the execution of services, provided to allow the execution of the services if the computer programs required for these services are available locally.

According to the invention, this device also comprises:
a module for acquiring computer programs, capable of triggering a download of the computer programs required for the services if these computer programs are not available locally,
and an automatic selective decision module for acquiring computer programs, capable of allowing and preventing the downloading of the computer programs required for these services and not available locally, at least according to the information associated with these services.

Thus, surprisingly, the invention relies neither on adaptation at transmission level, for example to systematically offer the most recent plug-ins early enough before the transmission of services using them, nor on adaptation at reception level, for example by increasing the resources of the terminals in terms of bandwidth and storage capacities. In contrast, the device of the invention relies on an interaction between transmission and reception, using both the information supplied on transmission (information on the computer programs required) and local information (availability of the required computer programs, decision criteria concerning the downloading).

In this way, the receiver can be adapted automatically and flexibly to the situation, by deciding whether or not to download the computer programs (preferably plug-ins) required by the services received subsequently. In a successful embodiment of the invention, the receiver is capable of triggering the downloading of the missing computer programs whenever this downloading is satisfactory to both the sender and the user of the services, and of avoiding this operation in the other cases. The content of a service is not therefore acquired by a terminal if the latter is incapable of executing it.

Thus, in the preferred embodiments that can be combined:
the downloading takes place only if it is completed when the service concerned is started up, given that initiating the service currently running is considered to be pointless (for example, interactive game during a transmission, in which missing the start of the game amounts to a certain loss);
the downloading takes place only if it is completed at a predefined moment before the end of the service concerned, given that initiating the service currently running is considered useful (for example, football results during a match);
the downloading takes place even if it cannot be used for the service concerned, because the downloaded computer program is very useful in general and will be available for other services, or will be useful for subsequent occurrences of the service concerned;
the downloading takes place only if it remains confined to a predefined bandwidth and/or it occupies only a predefined limited storage space.

The information sent may or may not be directly intended for this decision process. It may, in particular, be an indicator imposing the downloading of a plug-in in all circumstances, even if it means that this plug-in becomes available only during the execution of the service associated with this indicator, or even that this plug-in will not be downloaded in time for this service but will be useful for subsequent services. It may also concern information accessible in service announcement messages independently of this particular application, concerning, for example, the identity of the plug-in (as in the MHP standard). In all cases, an important aspect of the invention is the combination of the decision criterion at reception level and the use of this information.

Moreover, elements in addition to this information may be involved in the decision, such as, for example, local resources.

The decision device is advantageously incorporated in a terminal (such as, in particular, a television or an interactive radio set or an STB). However, in other embodiments, it is placed in an intermediate receiver between the transmitter and the terminals. For example, such a receiver is used for a group of terminals pooling bandwidth and storage reserves (company, building, etc.).

As for the communication network used to transmit the services, it may be one-way or bidirectional. The mode of transmission of the information associated with the services is applied preferably, but not necessarily, via this same network. For example, the services and the information are communicated by broadcasting over one and the same network via cable, microwave link or by satellite. In another example, the information is communicated by the Internet (or, more generally, by the return channel) before the associated services are broadcast.

A case that is particularly advantageous for its user-friendliness and its ease of implementation in light of the existing standards, is that in which the information is communicated within the very services concerned, in the service announcement messages, in particular for the ATVEF and MHP standards (the services including service announcement messages and contents). The reception module is then designed to receive the information associated with these services, in the service announcement messages, and the information identification module is designed to extract the information from these service announcement messages.

Thus, in a preferred embodiment, the interactive service incorporates both the information describing the plug-ins that it uses and information forcing or not forcing downloading, so that the terminal can decide whether or not to download these plug-ins. This information is advantageously entered when publishing the interactive service from a form, for example. Thus, when generating the interactive service data, this information is inserted in the files that make up the service. As for the terminal, it includes an algorithm for the decision whether or not to download plug-ins according to their size and the life span of the service.

In the analog TV and ATVEF world, this information is advantageously inserted in the SDP (Session Description Protocol, service announcement message payload format) part of the announcement in the form of a list of plug-ins required. This additional information is preferably indicated globally for all the service. In the case of an ATVEF service, for example, it is not actually desirable to indicate, in each of the HTML pages that make up the interactive service which plug-ins are required to execute this page. This would overload each page of the service and, above all, since a first page of a service might be displayable by the terminal but not a second page, the user would risk having access to only part of the service, without being able to navigate in it.

In the digital TV and DVB world, this information is advantageously inserted in signaling stream descriptors, in the form of identifiers assigned from tables listing all the existing and available plug-ins.

Knowing these prerequisites, the terminal can then decide initially whether to download the plug-in and software versions that may be required and not available, then, in a second stage, whether to display the interactive service.

Preferably, since the information associated with the services includes temporal information relating to the validity of execution of these services, the selective acquisition decision module is capable of allowing and preventing the downloading at least according to this temporal information. It is, in practice, interesting to take account of the chronology of a service (start, end, determining step, etc.) to decide whether or not to download, this chronology normally being synchronized with the broadcasting of associated programs.

Advantageously, the selective acquisition decision module is then designed to allow the downloading if this downloading is expected to be completed before predefined instants of the services, extractable from the temporal information, and to prevent this downloading otherwise.

Thus, according to a first manner in which this temporal information is taken into account, these predefined instants specify ends of validity of execution of the services. In the case of a lengthy service (such as a portal type service accessible continuously on a daily basis or the retransmission of a sporting event such as a football match), it is, in practice, important to download the missing plug-in(s) (operation taking only a few minutes) and then to offer the service to the viewer.

According to a second manner in which this temporal information is taken into account, these predefined instants specify starts of validity of execution of the services. The two forms are advantageously combined, inasmuch as some additional information received can be used to discriminate between the two cases (for example, a specific indicator concerning the decision criterion, or information on the type of service such as “portal accessible continuously”).

In cases in which the download authorization is dependent on predefined instants of the services, the selective acquisition decision module is preferably capable of acquiring downloading times of the computer programs required and not available locally, and thus of estimating when this downloading is expected to be completed. This mode of acquisition is advantageously obtained from information received such as the sizes of the computer programs, and local information such as the available bandwidth.

Preferably, since the information associated with the services includes at least one forced downloading indicator having an activated value and a deactivated value, the selective acquisition decision module is designed to forcibly allow the downloading if this forced downloading indicator has the activated value.

More specifically, and by way of example, even when downloading the missing plug-in(s) will not enable the current occurrence of a service to be displayed (downloading time longer than the life span of the service), it may, despite everything, be beneficial to force the terminal to download the missing component or components for one of the following reasons:
this interactive service (a short promotion, for example) must be transmitted n times during the month and each time the interactive promotion is transmitted, the terminal does not have time to download the plug-in; without the above arrangement, it would never therefore offer this service to the viewer; the embodiment with forced downloading indicator can be used to force the downloading of this plug-in so that the viewer can benefit from the remaining n−1 transmissions of the promotion;
this plug-in is so widely used that it is unavoidable; in this case, the embodiment with forced downloading indicator can be used to force all the terminals of the installed base to acquire it, even if it cannot be used by the service proposed at this moment.

In both these cases, it is intended that the downloaded plug-ins should be saved in permanent memory, that is, they should be installed in Flash memory or on hard disk.

Preferably, and in general, the conditional execution decision device of the invention also includes a module for acquiring sizes of the computer programs required and not available locally and the selective acquisition decision module is capable of allowing and preventing the downloading also according to these sizes.

A first way of using these sizes has already been mentioned above: the selective acquisition decision module is designed to estimate downloading times of the computer programs required and not available locally according to these sizes and local reception capabilities for the computer programs, and to allow the downloading when the latter allows an at least partial subsequent execution of the services.

According to a second way of using these sizes (that can be combined with the first), the decision module can decide not to allow the downloading even though the information arrives a long time before the content of an associated service, because the receiver has resources that are too limited given the size of one of the computer programs required. This resource limitation may be inherent to the receiver (modem too slow, disk space or, more generally, storage space, too limited) or result from the receiver operating mode (bandwidth needing to remain available mainly for other types of reception, and leaving only 10% free for example).

The invention also relates to a conditional decision method for the execution of services received via a communication network, corresponding to the conditional decision device of the invention, and preferably designed to be implemented using such a device according to any one of its embodiments.

The invention also applies to a device for compiling information messages associated with services, these messages being intended for transmission to users before execution of the associated services. This device includes means of incorporating in the messages information concerning computer programs required for the execution of these services.

According to the invention, the incorporation means are designed to include in this information at least one forced downloading indicator having an activated value and a deactivated value, this indicator being designed to forcibly allow the downloading of the computer programs required if the indicator has the activated value.

This message compilation device is preferably designed to produce messages intended for a conditional execution decision device according to any one of the embodiments of the invention.

The invention furthermore applies to an information message compilation method corresponding to the information message compilation device of the invention, preferably implemented using such a message compilation device.

Another object of the invention is to produce a computer program product comprising program code instructions for the execution of the steps of the conditional execution decision method or the information message compilation method according to the invention, when this program is run on a computer. The term “computer program product” is used to mean a computer program medium, which may consist not only of a storage space containing the program, such as a diskette or a cassette, but also of a signal, such as an electrical or optical signal.

The invention also relates to a control information message containing information intended to be utilized automatically by at least one receiver and associated with at least one service, this message being designed to be transmitted to the receiver before an execution of this service, and including information concerning at least one computer program required for the execution of this service.

According to the invention, this information includes at least one forced downloading indicator having an activated value and a deactivated value, this indicator being intended to forcibly allow the downloading of the computer program required if the indicator has the activated value.

The control information message of the invention is preferably intended to be produced by a message compilation device according to the invention.

The invention furthermore applies to a decoder, characterized in that it comprises a conditional execution decision device according to any one of the embodiments of the invention.

The invention will be better understood and illustrated by means of the following exemplary embodiments and implementations, by no means limiting, with reference to the appended drawings, in which:

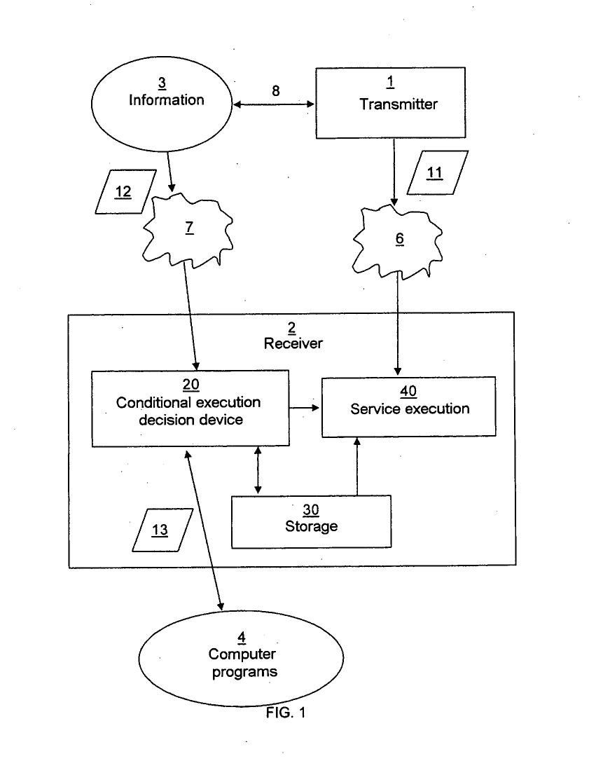

FIG. 1 is a schematic diagram of a transmission and reception system implementing a conditional execution decision device according to the invention;

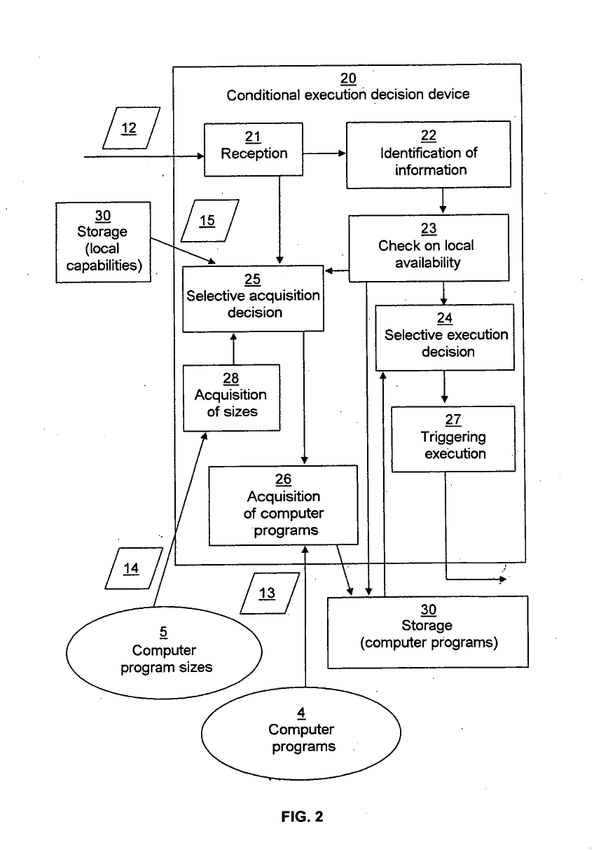

FIG. 2 represents in more detail, in block diagram form, the conditional decision device of FIG. 1;

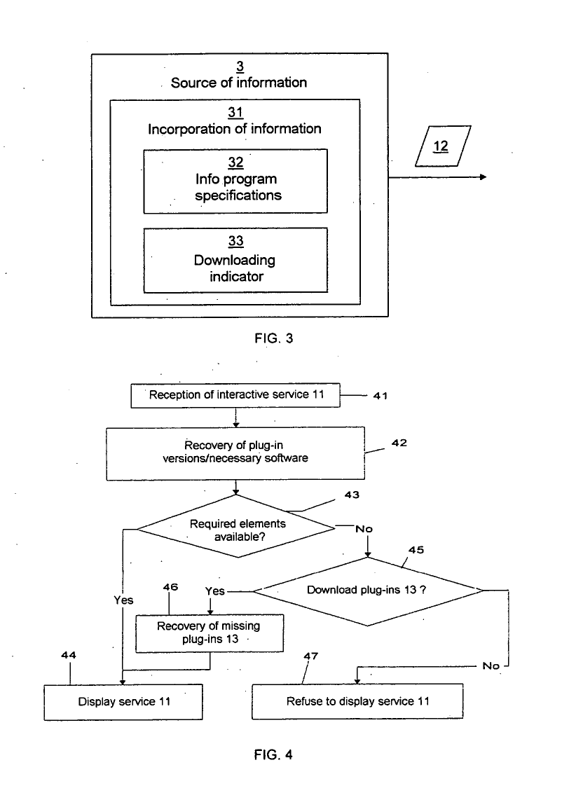

FIG. 3 shows an information message compilation device according to the invention, used in the system of FIG. 1;

FIG. 4 illustrates in flow diagram form a decision process concerning the display of a service by the conditional decision device of FIGS. 1 and 2;

FIG. 5 represents a software implementation of the system of FIG. 1, according to a first embodiment of the conditional execution decision device, with interactive terminal and applied to the ATVEF standard;

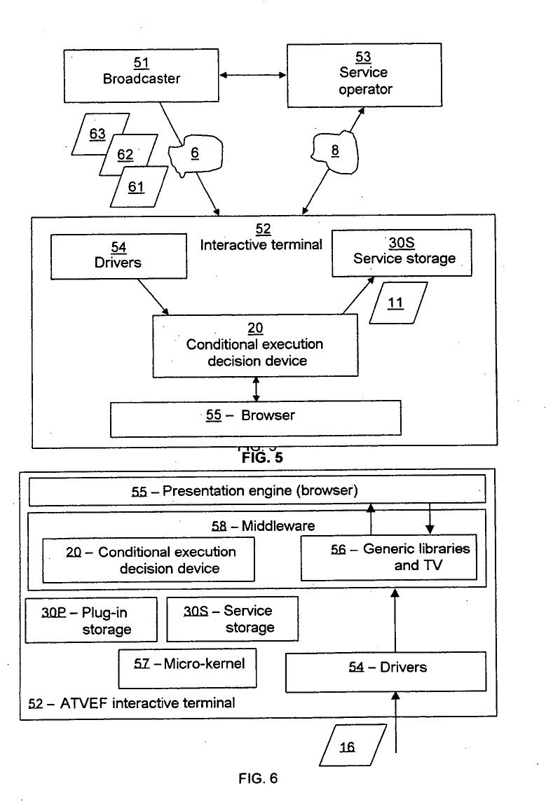

FIG. 6 details the interactive terminal of FIG. 5;

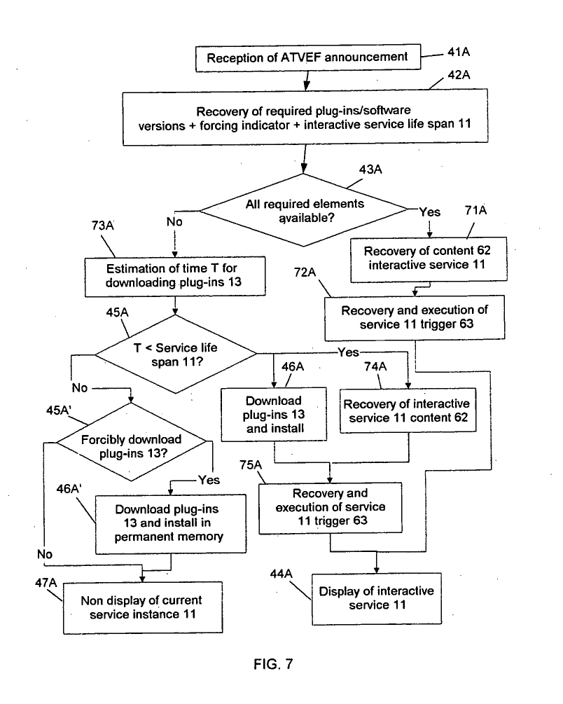

FIG. 7 develops, in flow diagram form, a decision process for the downloading of plug-ins and the display of a service, by means of the conditional execution decision device of the interactive terminal of FIGS. 5 and 6;

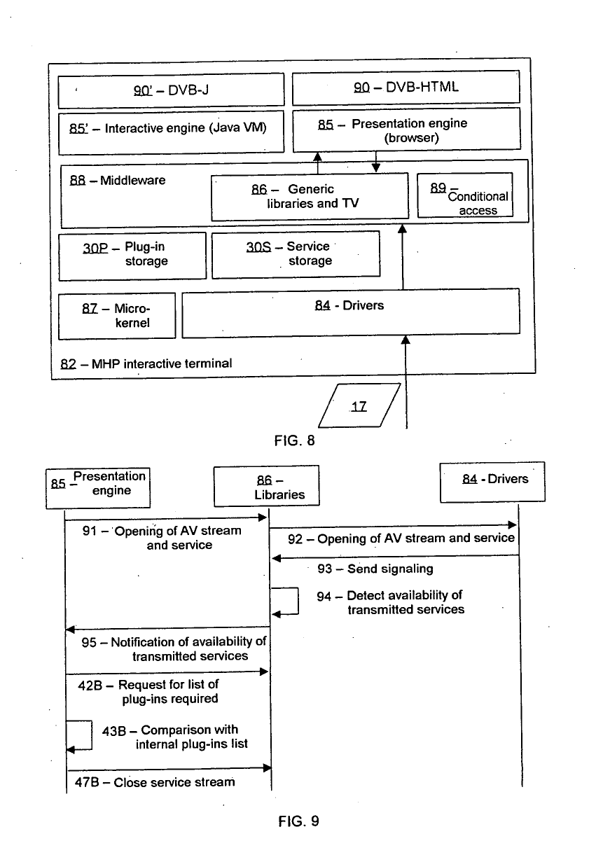

FIG. 8 details an interactive terminal incorporating a second embodiment of the conditional execution decision device of FIGS. 1 and 2, applied to the MHP standard;

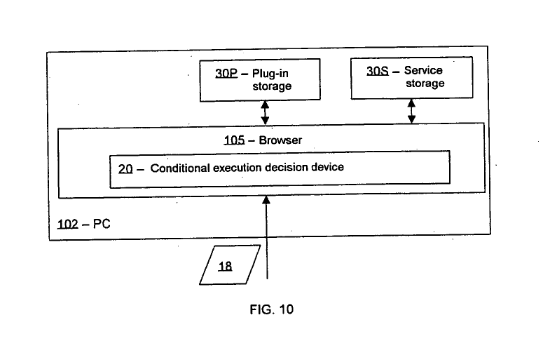

FIG. 9 illustrates a typical sequence of steps of a procedure obtained using the interactive terminal of FIG. 8;

and FIG. 10 diagrammatically represents a personal computer incorporating a third embodiment of the conditional execution decision device of FIGS. 1 and 2.

In the figures, identical or similar elements are denoted by the same references. Corresponding elements that have different identities are indicated by identical numbers and difference suffixes (the suffixes A and B respectively referring to the ATVEF and MHP standards).

Furthermore, the functional entities described and illustrated (in particular in FIGS. 1 to 3) do not necessarily correspond to physically different entities of the systems, but may, for example, consist of functionalities of one and the same software or of circuits of one and the same component. Conversely, one and the same module may be implemented in the form of a number of physically separate entities.

A transmission and reception system (FIG. 1) comprises a transmitter 1 and a receiver 2, communicating via a network 6, the transmitter 1 being designed to transmit services 11 to the receiver 2.

The receiver 2 is provided with a service execution unit 40 and a conditional decision device 20 for the execution of the services 11 received. It also has a storage space 30, provided to store in particular computer functionalities used to execute the services 11.

The transmission and reception system furthermore includes a source 3 of information relating to the transmitter 1 via a link 8, designed to provide the conditional decision device 20 with information 12 associated with the services 11 via a network 7 (which may be the same as the network 6). This information 12 includes in particular information relating to computer programs required for the execution of the services 11. A source 4 of computer programs is used by the conditional decision device 20 to trigger a downloading of computer programs 13 required for execution of the services 11 to the receiver 2, in particular for saving in the storage space 30.

More specifically (FIG. 2), the conditional execution decision device 20 comprises:
a module 21 for receiving the information 12 associated with the services 11,
a module 22 for identifying, within this information 12, information concerning the computer programs required to execute the services 11;
a module 23 for checking local availability (in the storage space 30) of the duly identified computer programs;
a selective decision module 24 for the execution of the services 11, if the computer programs required are available locally;
a module 27 for triggering the execution of these services 11 (at appropriate moments);
a selective decision module for the automatic acquisition 25 of the computer programs 13 required and not available locally, designed to allow or prevent the downloading of these computer programs; for this, the selective decision module 25 is capable of taking account not only of the information extracted from the information 12 and other elements included in this information 12 (such as, in particular, the start and end times of the services 11), but also of local capabilities 15 of the receiver 2, for example stored previously in the storage space 30, and of sizes 14 of the computer programs 13 required, accessible via a module 28 for acquiring sizes from a source 5 of sizes of these programs 13;
and a module 26 for acquiring the computer programs required 13 from the source 4 and, where necessary, storing these programs 13 in the storage space 13, on triggering of the selective acquisition decision module 25.

As for the information source 3 (FIG. 3), it comprises a device 31 for incorporating, within this information 12, information relating to the computer programs required. The device 31 itself includes a module 32 for incorporating specifications on these computer programs (name, version, etc.) and a module 33 for incorporating indications relating to the downloading of these computer programs (downloading mode, address to contact, etc.).

In operation, the conditional decision device 20 first receives, from the information source 3, information relating to computer programs required to execute services 11 which will follow from the transmitter 1. If all the computer programs required are already available to the receiver 2, the selective execution decision device 24 decides to execute the services 11 at the appropriate moment.

Otherwise, the selective acquisition decision device 25 applies a choice algorithm to decide whether the programs required and not available 13 need to be downloaded. If the response is positive, the selective acquisition decision module 25 initiates the downloading of the missing computer programs 13, by the acquisition module 26, from the source 4. In this case, if everything proceeds correctly and all the necessary computer programs are thus available to the receiver 2 in the required time, the selective execution decision module 24 decides to execute the services 11 at the appropriate time, as indicated previously. In the cases where the selective acquisition decision module 25 decides not to allow the downloading, or when this downloading is decided but proves defective, or even when it proceeds normally but is completed too late, the selective execution decision module 24 decides not to execute the services 11 concerned.

In one particular case (FIG. 4) in which the service 11 conforms to the ATVEF or MHP standard, the information 12 relating to an interactive service 11 is sent in an announcement message for this service. When the receiver 2 receives this announcement message (step 41), it identifies plug-in and software versions required to correctly display this service (step 42). It then checks whether all the required elements are available locally (step 43) and, if the response is positive, displays the interactive service at the appropriate moment (step 44). Otherwise, it takes a decision on whether to download the missing elements (step 45). If this decision is negative, it refuses to display the interactive service (step 47). If it is positive, it recovers the missing elements (step 46) and displays the interactive service (step 44).

More specific embodiments will now be detailed respectively for the ATVEF and MHP services, and in the personal computer (PC) world.

1/ A TVEF Services

The solution based on the ATVEF explained below applies equally to both analog and digital worlds. All the implications of the solution are detailed below (from the publishing of an interactive service through to its reception on a terminal).

Implementation when creating the interactive service 11 (information incorporation device 31) includes the insertion of the information 12 relating to this service in the announcement. In the context of the interactive TV technology marketed under the name of TAK, for example, this information 12 is entered at the time of publication of the interactive service 11, for example from a form. The company TAK supplies each service provider publishing interactive services with a service publication pack. This pack contains publication software and a simulator consisting of an interactive TV, a minimalist data server and a video insertion module. In a variant, the pack comprises only a personal computer (PC) and a television linked by a serial link or a universal serial bus (USB). The publication process thus comprises the following steps:
creation of the interactive service 11 (development of the interactive service by writing HTML pages, Flash animations, instructions in JavaScript language, etc., and by describing different triggers);
completion of a form describing the plug-ins used (for example, embedded Flash4 animation) and an indicator for forcing downloading;
and generation of the ATVEF files making up this interactive service 11 (generation of the ATVEF announcement, of all the contents—HTML pages and, where appropriate, Flash and picture files—and of the triggers).

Regarding the format of the information 12, a first field is used to describe the media by indicating the plug-in(s) required. This description is made up of two parameters:

the format of the media (Flash, MP3, etc.), and

the version of this media,

this field being repeated as many times as there are plug-ins. Another unique field is used to force the downloading and installation of the missing plug-ins.

For example, the announcement is encapsulated according to transport layers compliant with the ATVEF standard in Europe, and comprises a header in SAP (Session Announcement Protocol) format and a payload in SDP (Session Description Protocol) format, see document RFC 2327—Request For Comment). The information describing the interactive service 11 is included in the SDP, which offers an attribute field “a=” that can be adapted by the user.

The list of plug-ins used and the required version are inserted in the SDP in the form:

a=<attribute>:<value>

with:

<attribute>=mediaFormat or mediaVersion

and

<value>=character string.

For the mediaVersion attribute, which is optional, <value> is then of the type:

<VersionMajor[Separator][VersionMinor]>

the VersionMajor field being mandatory and the separator, which must be known to the terminals, being of use only when VersionMinor is specified.

For example, if dealing with a plug-in of the type MyPlugin 4.3 and if the chosen separator is the comma (“,”), then:

mediaFormat=MyPlugin

mediaVersion=4.3

If the mediaVersion field is present, it is necessarily attached to the preceding mediaFormat field. If absent, then either there is no version to be specified, or only the basic functions offered by the plug-in are to be used, therefore the service can be displayed correctly whatever version of the plug-in is present.

The indicator for forcing the downloading of the plug-ins, if they are absent, is also inserted in the SDP in the form:

a=mediaDownload: true or false

By default, if this mediaDownload attribute is not indicated, it is considered to be inactive (false). Consequently, the terminal then takes the decision to download the plug-in(s) or not. Otherwise, if it is assigned the value true, then in all cases, the plug-ins are downloaded.

An example of SDP is expanded below:

v=0

o=−921216992 921216992 IN IP4 172.30.90.160

s=TMM

e=dupont@thmulti.com

p=+1-6504704860

a=lang:en

a=tve-ends:300

a=tve-type:primary

a=tve-id:79f3711c40c3-11c4-ded7-1932f6457700

a=tve-profile:1

a=mediaFormat: Flash

a=mediaVersion: 4

a=mediaFormat: MHEG-5

a=mediaFormat: MP3

a=mediaDownload: true

sdpattribute=foo

t=2873397496 2873404696

m=data 22814 tve-trigger

c=IN IP4 227.37.32.27

m=data 22815 tve-file

c=IN IP4 224.37.32.21

In this example, the browser of the terminal must support Flash4, multimedia applications according to the MHEG (Multimedia Hypermedia Expert Group) standard, and audio files in MP3 format. Furthermore, if one or more components are absent, they must be downloaded.

It is interesting to note that:
these attributes are media level attributes and not session level attributes, that is, they are used to describe the media but they are independent of the current session;
these media description attributes must be inserted after the session description attributes (see RFC 2327);
and if a receiver “does not understand” these attributes, then it disregards them.

The implementation of this embodiment in an interactive terminal 52 (FIG. 5) for analog television will now be explained. The terminal 52 comprises, in software component form:
one or more VBI (Vertical Blanking Interval) drivers 54, designed to extract data transported in the received AV signal (services 11 and information 12); in the digital TV world, this component is replaced by a demultiplexer;
a browser 55, responsible for managing the interactive services 11; it displays the services 11, receives commands from a viewer via a remote control and executes requested actions (hyper-navigation, execution of a script, etc.);
the conditional execution decision device 20 (in software form), capable of recovering the plug-ins 13 required to display the services 11 and not available;
and the interactive services 11 (possibly including in particular HTML pages, instructions in JavaScript language and Flash animations) in a storage area 30S.

A broadcaster 51 (the transmitter 1) communicates the ATVEF services 11 to the terminal 52 via the network 6, each of these services 11 comprising an announcement 61, content(s) 62 and trigger(s) 63. This broadcaster 51 is bilaterally connected with a service operator 53, who communicates with the terminal 52 via a bidirectional communication network 8.

The decisions as to whether to download and display one of the services 11 are advantageously taken by the conditional execution decision device 20 before even the acquisition of the content 62 of this service, so as not to load the terminal 52 with useless data that it is in any case incapable of processing. Before opening listening channels on the content 62 and the triggers 63, the interactive terminal 52 thus checks whether it is able to display the interactive service 11 on receiving the announcement 61. If it is not able to display it (it does not have all the plug-ins required and does not have the time to download them before the end of life of the service 11), then it may not start to listen to the content 62 and disregard it.

More specifically, the interactive terminal 52 (FIG. 6) comprises (software components and associated storages), in addition to the drivers 54, the browser 55 and the storage area 30S for the services 11, a micro-kernel 57, “middleware” (software used transparently between application and network software) 58 including generic and television (broadcasting, communication) libraries 56, as well as the conditional execution decision device 20, and a storage area 30P for plug-ins.

In operation, on receiving a transmitted audio-visual stream 16, the drivers 54, tuner (not shown) and VBI slicer (not shown) separate the information data from the video and audio programs. The audio-visual programs are then offered to the viewer and, if there is one, an interactive service 11 is a candidate for display on screen. It is at this point that the filtering process applied by the conditional execution decision device 20 takes place (FIG. 7).

The filtering process comprises the following steps:
reception of an ATVEF packet in the form of a stack of protocols required in the world of analog TV in Europe, and extraction of the IDL B (independent Data Line) level packets, de-encapsulation of the IDL B and SLIP (Serial Line Internet Protocol) layers and verification and correction if necessary of the error codes (FEC, Forward Error Correction); direction of the duly obtained UDP (Unidirectional Data Protocol)/IP packets to the browser 55 by the generic broadcasting libraries 56;
if a packet arrives over the ATVEF announcements 61 listening channel (step 41A), then the browser 55 de-encapsulates it and recovers the SDP payload;
the conditional execution decision device 20 carries out various checks, and recovers the parameters and the list of plug-ins required to execute the service 11 concerned (step 42A); it also recovers the value of the indicator capable of forcing the downloading of the plug-ins and the life span of the interactive service 11 (tve_ends field of the SDP payload, value indicated by the attribute t=<start time><stop time>);
the device 20 compares the list of plug-ins required with an embedded list (step 43A);
if the plug-ins required by the transmitted service are present in the list of embedded plug-ins, then the service 11 is accepted, that is, the browser 55 then opens a listening channel on the ATVEF content 62 (recovery of the content 62 in the step 71A) and a listening channel on the triggers 63 (recovery of the triggers 63 in the step 72A); the interactive service 11 is thus displayed (step 44A);
otherwise, the device 20 estimates the time to download all the missing required plug-ins 13 (step 73A) and compares it with the life span of the service (step 45A);
if this time (plus a constant) is greater than the expiry date of the service 11, then the device 20 checks the value of the plug-in download forcing indicator (step 45A′); depending on the case, the downloading or not of the plug-ins 13 is performed (step 46A′ for the forced downloading), but the service 11 is in no circumstances acquired and displayed (step 47A); in the case where the plug-ins 13 are downloaded, they are then installed in permanent memory;
if this time (plus the constant) is less than the expiration date of the service 11, then the downloading of the plug-ins is performed (step 46A) and, in parallel, the service 11 is acquired (step 74A, the browser 55 then opens a listening channel on the ATVEF content 62 and a listening channel on the triggers 63); once the plug-ins are installed on the terminal 52, the browser 55 listens to the channel opened on the triggers 63 and when a display trigger is received (step 75A), displays the service 11 (step 44A).

The estimation of the time to download a plug-in that is required and not available 13 and the downloading methods will now be detailed.

The plug-in 13 can be recovered via two types of channels: either by broadcasting (from the broadcaster 51 or from another transmitter), or by a bidirectional communication with a server (via the return channel from the service operator 53 or from another source).

By broadcasting, the operator of the terminals or the service operator 53 can use known means for this type of update. For example, he transmits a signaling describing to the terminal 52 the means of recovering the plug-ins transmitted from elsewhere. The terminal 52, by analyzing this signaling, can then apply a procedure for downloading the missing plug-ins 13. The advantage of this method is that it is not costly for the user of the terminal 52, because no telephone connection is required. A particular implementation of such a method can be found described in the document EP-1.245.116, which explains methods of transmitting and receiving update data. According to the disclosed technique, announcement signals, indicating the time when the update data will subsequently be transmitted, precede the transmission of this data.

By communication with a server, the operator of the terminals or the service operator 53 can use known means for this type of update. For example, he transmits a signaling describing to the terminal 52 the means of recovering the plug-ins 13 available elsewhere on an on-line server. The terminal 52, by analyzing this signaling, then applies a procedure for downloading the missing plug-ins 13 via the telephone or ADSL (Asymmetric Digital Subscriber Line) channel. According to another mechanism, a connection to a server is initiated and a negotiation is started, transparent to the user of the terminal 52, between the terminal 52 and the server. The server then supplies the terminal 52 with the missing plug-ins 13.

The estimated download time depends on the type of channel used to recover it (bit rate) and the size of the plug-in 13. Concerning recovery of the size, the method can involve use of a broadcasting channel, bidirectional communication with a server or the use of embedded information.

By broadcasting, the operator of the terminals or the service operator 53 continuously transmits a signaling stream indicating the current sizes of each of the latest available plug-in versions. The advantage of this method is its speed, because there is no need to connect to and interrogate an on-line server (waste of time).

By communication with a server, the terminal 52 is configured to connect to an on-line server that can indicate to it all the known plug-in sizes. The advantage of this method is a saving on bandwidth, because there is no need to transmit data continually.

For the use of embedded information, the terminal 52 has a known plug-ins description table, embedded in permanent memory. This table can be updated regularly either by broadcasting (transmission of the table in a stream in each downloading session), or on line, when the viewer connects, for example. The advantage of this method is that it immediately offers the size of the required plug-in 13 (the terminal 52 is then able to take the decision quickly).

The various methods can also be combined. For example, the terminal 52 begins by looking for the size of the required plug-in 13 in the embedded table. If this plug-in 13 is not there (the table is too old), the terminal 52 initiates a connection to an on-line server to recover the information.

2/ MHP Services

This family of embodiments exclusively concerns the digital world.

For implementation on creation of the interactive service 11 (information incorporation device 31), the information concerning the types of applications used (for example, embedded Flash4 animation) is entered at the time of publication of this service 11, for example from a form. Thus, a file is generated containing the sources of the interactive service 11 and all the information relating to the correct execution of this service (timing for the triggers, list of plug-ins required, etc.). On creation of an MPEG (Moving Picture Experts Group) stream, this file is imported and the various information is entered in the stream descriptors. The format of this information is the one used in the world of digital TV according to the MHP standard.

There now follows a detailed description of a particular implementation of the conditional execution decision device 20 in an interactive MHP terminal referenced 82 (FIG. 8). The terminal 82 comprises software and storage components which include:
drivers 84;
middleware 88 including generic and TV libraries 86 (DVB-SI data—for “Service Information”, communication, etc.), a conditional access unit 89 and the conditional execution decision device 20;
a presentation engine 85 (browser) associated with a DVB-HTML unit referenced 90;
an interactive engine 85′ (Java VM) associated with a DVB-J unit referenced 90′;
a micro-kernel 87;
and storage areas 30S and 30P respectively for interactive services and plug-ins.

In operation, on reception of a transmitted MHP stream 17, the drivers 84, a tuner and a demultiplexer are used to extract first of all the PMT (Program Map Table) from the MPEG2 stream to recover the signaling describing the content of the stream 17 received.

On the one hand, the audio-visual programs are then offered to the viewer and on the other hand, if there is one, an interactive service 11 is a candidate for display on the screen. It is at this point that the filtering process of the conditional execution decision device 20 is applied.

The steps of the method can be described as follows (FIG. 9):
opening of the audio-visual and service streams (steps 91 and 92), and extraction of MPEG2 packets containing the signaling;
recovery of the signaling by the drivers 84 and transmission to the libraries 86 (step 93), which detect the availability of the service 11 (step 94) and report it to the conditional execution decision device 20 (step 95);
the libraries 86 responsible for managing the SI are used to recover a data_broadcast_id descriptor and thus compile the list of plug-ins necessary for the service 11 to be displayed correctly on the screen of the viewer; this operation is driven by the middleware 88 (step 42B);
this list is analyzed then compared with a resident list of embedded plug-ins (step 43B) by the device 20;
if the plug-ins required by the transmitted service are present in the list of embedded plug-ins, then the service 11 is accepted; otherwise, the device 20 decides whether a downloading of the missing plug-ins 13 is required, in a manner similar to that explained for ATVEF; if, as in the example shown, the device 20 decides not to proceed with the downloading, the service 11 is disregarded (step 47B).
   3/ PC World

The main interest is in the interactive applications for TV on PC (the PC being connected to a broadcasting network). When an HTML page is published (information incorporation device 31), pairs of name and value fields “Name/Value” are defined to specify plug-ins required to execute a service 11. These pairs are introduced in meta-data contained in the header of the HTML page, as follows:

<META NAME=“mediaFormat” CONTENT=“<Plugin_Name>, [version]”>

with:

<Plugin_Name>: mandatory parameter

[version]: optional parameter indicating, if necessary, a minimum version of the required plug-in.

The indication whether the missing plug-ins 13 must be downloaded or not with forcing is inserted as follows:

<META NAME=“mediaDownload” CONTENT=“<TRUE or FALSE>”>

with:

if TRUE, forced downloading of the missing plug-ins 13;
and if FALSE, decision by the browser 105 whether or not to download the plug-ins 13 according to the life span of the service 11.

A concept of service life span is also inserted:

<META NAME=“ServiceValidityWindow” CONTENT=“<Start Time>, <End Time>”>

The HTML page takes the following form for example:

| <HTML> | |
|---|---|
| <!-- CREATION DATE: 14/12/99 --> | |
| <HEAD> | |
| <TITLE></TITLE> | |
| <META NAME=“Description” CONTENT=“”> | |
| <META NAME=“Keywords” CONTENT=“”> | |
| <META NAME=“Author” CONTENT=“Frederic Pasquier”> | |
| <META NAME=“mediaFormat” CONTENT=“Flash, 4”> | |
| <META NAME=“mediaFormat” CONTENT=“MP3”> | |
| <META NAME=“mediaFormat” CONTENT=“MHEG-5”> | |
| <META NAME=“mediaDownload” CONTENT=“TRUE”> | |
| <META | NAME=“ServiceValidityWindow” |

CONTENT=“2873397496,
2873404696”>
</HEAD>
<BODY>
.. HTML code using Flash 4, MP3 and PNG, etc. formats
</BODY>
</HTML>

A PC 102 capable of implementing the conditional execution decision device 20 (FIG. 10) comprises a browser 105 incorporating this device 20, and storage areas 30P and 30S respectively for plug-ins and services. The browser 105 is designed to be able to recover and understand the Name/Value pairs defined above.

In operation, the PC 102 receives a stream 18 comprising an HTML page with a header as described above. The browser 105 then decides whether or not to download and install the plug-ins required 13 and display the corresponding service 11, according to a method similar to the one explained previously for ATVEF. The plug-ins available or downloaded are always installed on the hard disk.

1. A conditional decision device for the execution of services received via a communication network, said received services having predetermined life spans, said device comprising:
a module for receiving information associated with said services, provided to receive said information prior to the execution of said associated services,
a module for identifying, from said information received, information concerning computer programs required to execute said services associated with said information,
a module for checking the local availability of said identified computer programs,
and a selective decision module for the execution of services, provided to allow the execution of said services if said computer programs required for said services are available locally,
further comprising said device also comprises:
a module for acquiring computer programs, capable of triggering a download of said computer programs required for said services if said computer programs are not available locally,
and an automatic selective decision module for acquiring computer programs, capable of allowing and preventing the downloading of said computer programs required for said services and not available locally, at least according to said information associated with said services.

2. The conditional execution decision device as claimed in claim 1, wherein since said information associated with said services includes temporal information relating to the validity of execution of said services, the selective acquisition decision module is capable of allowing and preventing said downloading at least according to said temporal information.

3. The conditional execution decision device as claimed in claim 2, wherein the selective acquisition decision module is designed to allow said downloading if said downloading is expected to be completed before predefined instants of said services, extractable from said temporal information, and to prevent said downloading otherwise.

4. The conditional execution decision device as claimed in claim 3, wherein said predefined instants specify ends of validity of execution of said services.

5. The conditional execution decision device as claimed in 3, wherein said predefined instants specify starts of validity of execution of said services.

6. The conditional execution decision device as claimed in 3, wherein the selective acquisition decision module is capable of acquiring downloading times of said computer programs required and not available locally, and thus of estimating when said downloading is expected to be completed.

7. The conditional execution decision device as claimed in claim 1, wherein since said information associated with said services includes at least one forced downloading indicator having an activated value and a deactivated value, said selective acquisition decision module is designed to forcibly allow said downloading if said forced downloading indicator has the activated value.

8. The conditional execution decision device as claimed in claim 1, further comprising a module for acquiring sizes of said computer programs required and not available locally and the selective acquisition decision module is capable of allowing and preventing said downloading also according to said sizes.

9. The conditional execution decision device as claimed in claim 8, wherein the selective acquisition decision module is designed to estimate downloading times of said computer programs required and not available locally according to said sizes and local reception capabilities for said computer programs, and to allow said downloading when said downloading allows an at least partial subsequent execution of said services.

10. The conditional execution decision device as claimed in claim 1, wherein since said services include messages of announcement of services and contents, the reception module is designed to receive said information associated with said services, in said announcement messages of services and the information identification module is designed to extract said information from said service announcement messages.

11. A conditional decision method for the execution of services received via a communication network, said received services having predetermined life spans, said method comprising:
a step for the reception of information associated with said services prior to the execution of said services,
a step for identifying, from said received information, information concerning computer programs required for the execution of said services associated with said information,
a step for checking the local availability of said identified computer programs,
and a selective decision step for the execution of services, in which an execution of said services is allowed if said computer programs required for said services are available locally,
further comprising said method also comprises:
a step for acquiring computer programs, by downloading said computer programs required for said services if said computer programs are not available locally,
and a selective decision step for automatically acquiring computer programs, in which a decision is made to enable or prevent the downloading of said computer programs required for said services and not available locally, at least according to said information associated with said services,
said method being preferably designed to be implemented using a conditional execution decision device as claimed in claim 1.

12. A device for compiling information messages associated with services, said messages being intended for transmission to users before execution of said associated services, said device including means of incorporating in said messages information concerning computer programs required for the execution of said services wherein said incorporation means are designed to include in said information at least one forced downloading indicator having an activated value and a deactivated value, said indicator being designed to forcibly allow the downloading of said computer programs required if said indicator has the activated value,
said message compilation device being preferably designed to produce messages intended for a conditional execution decision device as claimed in claim 1.

13. A method of compiling information messages associated with services, said messages being intended for transmission to users before execution of said associated services, said method including a step for incorporating in said messages, information concerning computer programs required for the execution of said services wherein on said incorporation step, at least one forced downloading indicator having an activated value and a deactivated value is included in said information, said indicator being intended to forcibly allow the downloading of said computer programs required if said indicator has the activated value,
said message compilation method being preferably implemented using a message compilation device as claimed in claim 12.

14. A computer program product comprising program code instructions for the execution of the steps of the method as claimed in claim 11 when said program is run on a computer.

15. A control information message containing information intended to be utilized automatically by at least one receiver and associated with at least one service, said message being designed to be transmitted to said receiver before an execution of said service, and including information concerning at least one computer program required for the execution of said service,
wherein said information includes at least one forced downloading indicator having an activated value and a deactivated value, said indicator being intended to forcibly allow the downloading of said computer program required if said indicator has the activated value,
said control information message being preferably intended to be produced by a message compilation device as claimed in claim 12.

16. A decoder, further comprising a conditional execution decision device as claimed in claim 1.
